(19) United States
(12) Patent Application Publication
(10) Pub. No.: US 2014/0266110 A1
(43) Pub. Date: Sep. 18, 2014

(54) Duty-Cycle Dependent Slope Compensation for a Current Mode Switching Regulator

(71) Applicants: Henry H. Yuan, Fremont, CA (US); Steve X. Chi, Cupertino, CA (US); Ekram H. Bhuiyan, San Jose, CA (US)

(72) Inventors: Henry H. Yuan, Fremont, CA (US); Steve X. Chi, Cupertino, CA (US); Ekram H. Bhuiyan, San Jose, CA (US)

(21) Appl. No.: 13/840,035

(22) Filed: Mar. 15, 2013

(51) Int. Cl. H02M 3/156

(52) U.S. Cl. CPC H02M 3/156
USPC 323/282

(57) ABSTRACT

An electronic circuit may output a slope compensation signal for performance of slope compensation of a current mode switching regulator. The circuit may generate a voltage across a storage device that is supplied to a voltage-to-current converter, which may generate a first current in response to the supplied voltage. Current mirror circuitry may mirror the current and supply the mirrored current to the storage device to generate the voltage. The current mirror circuitry may also mirror the current to generate a second mirrored current, which may be supplied to an output of the electronic circuit. In addition to using the first mirrored current to generate the voltage, the voltage may be generated by pulling down the voltage to ground in accordance with a duty cycle of a switching signal used for generation of an output of the current mode switching regulator.

### BACKGROUND

Power conversion circuitry may be used to provide regulated voltages to electronic circuits. One type of power conversion circuitry is a direct current-to-direct current (DC-to-DC) regulator. A DC-to-DC regulator may convert a DC input voltage received from an energy source, such as a battery, to a DC output voltage, which may be provided to an output load. The DC-to-DC regulator may be a switching regulator that uses switching circuitry to generate a regulated DC output voltage. Switching regulators may use pulse width modulation (PWM), in which an amount of energy proportional to a pulse width of a PWM signal is transferred through switching circuitry to maintain the DC output voltage.

Under certain situations, a current mode switching regulator may exhibit instability. For example, when a duty-cycle of the PWM signals exceeds fifty percent, current being transferred through an inductor to a load may experience a cycle-by-cycle increase in deviation from a nominal value of minimum peak current through the inductor, which may cause unstable operation of the regulator.

### SUMMARY

Embodiments of the present invention are defined by the claims, and nothing in this section should be taken as a limitation on those claims. By way of example, the embodiments described in this document and illustrated in the attached drawings generally relate to a slope compensation circuit, and to a method of generating a slope compensation output for performance of slope compensation by a regulator.

In one example, a slope compensation circuit is configured to perform slope compensation for a current mode switching regulator. The current mode switching regulator may include switching circuitry to control flow of ramp up and ramp down portions of electrical current through an inductor to generate an output voltage. The switching circuitry may be responsive to a switching signal having a period with a first time duration that corresponds to the ramp up portion and a second time duration that corresponds to the ramp down portion. The first time duration is proportional to a duty cycle of the switching signal. The slope compensation circuit includes: a storage device configured to generate a voltage; pull down circuitry configured to pull down the voltage to a level corresponding to a logic low based on the duty cycle of the switching signal; and a voltage-to-current converter configured to generate a first current based on the voltage. The slope compensation circuit also includes current mirror circuitry configured to: mirror the first current to generate a second current and supply the second current to the storage device for generation of the voltage; and mirror the first current to generate a third current and supply the third current to an output of the slope compensation circuit for generation of a slope compensation output.

In sum, the compensation slope circuit may output a slope output that is duty-cycle dependent such that there is minimal slope compensation for an entire range of duty cycles. In this way, slope compensation may be performed without overcompensation at lower duty cycles.

These and other embodiments, features, aspects and advantages of the present invention will become better understood from the description herein, appended claims, and accompanying drawings as hereafter described.

### BRIEF DESCRIPTION OF THE DRAWINGS

The accompanying drawings, which are incorporated in and constitute a part of this specification illustrate various aspects of the invention and together with the description, serve to explain its principles. Wherever convenient, the same reference numbers will be used throughout the drawings to refer to the same or like elements.

FIG. 1 is schematic diagram of an example current mode switching regulator with slope compensation.

FIG. 2 is a schematic circuit diagram of an example buck regulator topology.

FIG. 3 is a schematic circuit diagram of an example boost regulator topology.

FIG. 4 is a schematic circuit diagram of an example buck-boost regulator topology.

FIG. 5 is a schematic circuit diagram of an example non-inverting buck-boost regulator topology.

FIG. 6 is a graph showing timing relationships between a clock signal, a set signal, a control signal, a ramp signal, and a reset signal.

FIG. 7 is a schematic diagram of the example current mode switching regulator shown in FIG. 1 having an example buck configuration.

FIG. 8 is schematic circuit diagram of a slope compensation circuit of the current mode switching regulator shown in FIG. 1.

FIG. 9 is a graph showing timing relationships between a clock signal, a set signal, a reset signal, voltages generated by a switching regulator, and a compensation ramp signal.

FIG. 10 is a graph showing the output of the slope compensation circuit of FIG. 7 compared to other slope compensation outputs.

FIG. 11 is a flow diagram of an example method of generating a slope compensation output.

### DETAILED DESCRIPTION

Various modifications to and equivalents of the embodiments described and shown are possible and various generic principles defined herein may be applied to these and other embodiments. Thus, the claimed invention is to be accorded the widest scope consistent with the principles, features, and teachings disclosed herein.

The present description describes electronic circuits and circuit systems that output slope compensation signals for performance of slope compensation to prevent or minimize unstable operation of a current mode switching regulator. The current mode switching regulator may use switching circuitry to generate a regulated DC output voltage. The switching circuitry may be controlled by switching signals with associated duty cycles, which may be adjusted to control and/or adjust the DC output voltage. The slope compensation output may be duty-cycle dependent on the duty cycles of the switching signals such that there is minimal slope compensation for an entire range of duty cycles, from 0% to 100%. In this way, slope compensation may be performed without overcompensation at lower duty cycles.

FIG. 1 shows a block diagram of an example current mode switching regulator 100 that includes a slope compensation circuit or circuitry 102. The current mode switching regulator 100 may convert a DC input voltage V_{IN} received at an input 108 of the switching regulator 100 to a DC output voltage V_{OUT} generated at an output 103. An output capacitor C_{OUT} may be included at the output 103 to generate and/or maintain the DC output voltage V_{OUT}. The current mode switching regulator 100 may include inductor and switching circuitry 104 to generate the DC output voltage V_{OUT}. The inductor and switching circuitry 104 may include an inductor 105 to store energy. The switching circuitry 107 may be connected to the inductor 107 and to ground GND to determine or control current flow I_{L} through the inductor 105 to generate the output voltage V_{OUT}. The switching circuitry 107 may include one or more transistors, which may be of various types, such as bipolar junction transistors (BJTs) or field-effect transistors (FETs) including metal-oxide-semiconductor FETs (MOSFETs), as examples. In addition, some example configurations of the switching circuitry 107 may include diodes. An average current flow through the inductor 105 may be based on current generated at the output 103.

The current I_{L} through the inductor 105 may include a ramp up portion and a ramp down portion. The switching circuitry 107 may be configured to switch between states to determine or control the flow of the inductor current I_{L} through the inductor 105, including the ramp up and the ramp down portions. For some configurations, the switches of the switching circuitry 107 may be configured to switch between “on” and “off” states, which may determine the states of the switching circuitry 107. As described in more detail below, switching signals may be used to switch the switches in the switching circuitry between the states to control the ramp up and ramp down portions of the inductor current I_{L}. Various configurations are possible.

FIGS. 2-5 show various switching regulator topologies for the inductor and switching circuitry 104, including various configurations or combinations of the storage circuitry 105 and the switching circuitry 107 shown in FIG. 1. FIG. 2 shows a step-down or buck switching regulator topology 204. Step-down or buck switching regulators may generate an output voltage V_{OUT} that is less than the input voltage V_{IN}. In a first state of the switching circuitry 207, the input voltage V_{IN} may be connected to the inductor 205, and the inductor 205 may both charge and discharge current to the output 203. In a second state of the switching circuitry 207, the input voltage V_{IN} may be disconnected from the inductor 205, and the inductor 205 may only discharge current to the output 203.

FIG. 3 shows a step-up or boost switching regulator topology 304. Step-up or boost switching regulators may generate an output voltage V_{OUT} that is greater than the input voltage V_{IN}. For the boost switching regulator topology 300, the input voltage V_{IN} is connected to the inductor 305, independent of the state of the switching circuitry 307. In a first state of the switching circuitry 307, the inductor 305 is disconnected from the output 303. In a second state of the switching circuitry 307, the inductor 305 is connected to the output 303.

FIG. 4 shows a buck-boost switching regulator topology 404, which may be an inverting buck-boost topology. Buck-boost switching regulator topologies may be configured to invert a negative output voltage V_{OUT} from the input voltage V_{IN}. For the buck-boost switching regulator topology 404 shown in FIG. 4, the inductor 405 is alternatingly connected to the input 408 or the output 403, depending on the state of the switching circuitry 407.

FIG. 5 shows a configuration of a dynamic buck-boost switching regulator topology 504, which may be a non-inverting (either step up or step down output voltage) buck-boost topology. The switching circuitry 507 for the topology 504 may include two portions, a first switching circuitry portion 507a and a second switching circuitry portion 507b. The first switching circuitry portion 507a may alternatively connect a first end of an inductor 505 with the input 508 to receive the input voltage V_{IN} or ground GND. Similarly, the second switching circuitry 507b may alternatingly connect a second, opposing end of the inductor 505 with the output 503 to generate the output voltage V_{OUT} or ground GND. In some configurations, when the first end of the inductor 505 is connected to the input 508, the second end is connected to ground GND, and when the first end of the inductor 505 is connected to ground GND, the second end is connected to the output 503.

Referring back to FIG. 1, the current mode switching regulator 100 may include driver circuitry 110 to control the switching circuitry 107. In particular, the driver circuitry 110 may be configured to output switching signals to the switching circuitry 107 to determine the states of the switching circuitry 107. The switching signals may turn switches in the switching circuitry 107 “on” and “off,” which may determine the flow of current I_{L} through the inductor 105, including the ramp up and ramp down portions.

The switching signals may have characteristics that determine the state of a switch, such as whether the switch is “on” or “off,” and/or for how long the switch is “on” or “off.” Example characteristics may include waveform, frequency, period, pulse width, and/or duty cycle. In accordance with these characteristics, the switching signals may generally oscillate between high and low levels, such as voltage levels corresponding to logic “high” and logic “low” levels to turn the switches “on” and “off.” In one example, the switching signals may be pulse-width modulated (PWM) signals, although other types of switching signals may be used.

A period of the switching signal may correspond to and/or be determined by a clock signal CLK used to control timing and clocking in the switching regulator 100. A duty cycle of the switching signals may determine a duration of the switching signal's pulse width over the period, or the amount of time that the switching signal is “high” and “low” over the period. The duty cycle, which may be identified in terms of a percentage or ratio, may identify a relationship between a pulse duration and a period of the switching signal or the clock signal CLK. For example, a fifty percent (50%) duty cycle may refer to the switching signal having a pulse width that is about half or 50% of its period or the period of the clock signal CLK corresponding to the switching signal.

The duty cycle of the switching signal may determine how long a switch in the switching circuitry 107 is “on” or “off,” which may determine the flow of current through the inductor 105, and which in turn may determine the DC output voltage V_{OUT}. For some configurations, a greater duty cycle may yield a larger DC output voltage V_{OUT}, and a smaller duty cycle may yield a smaller DC output voltage V_{OUT}. As such, energy in the switching signals, which may be proportional to the pulse width of the switching signals, may determine a corresponding DC output voltage V_{OUT}. Further, regulation of the output voltage V_{OUT} may be achieved by adjusting or modulating the pulse widths or duty cycles of the switching signals.

The current mode switching regulator 100 may include PWM control circuitry 116 in communication with the driver circuitry 110 to control the driver circuitry 110 and to determine the duty cycles of the switching signals. The PWM control circuitry 116 may output control signals to the driver circuitry 110 to generate switching signals having desired characteristics. For example, the control signals output by the PWM control circuitry 116 may determine the pulse widths or duty cycles and periods of the switching signals. Other characteristics of the switching signals, such as amplitude, frequency and/or timing of the output of the switching signals, may also be determined and/or controlled by the PWM control circuitry 116. In some configurations, the PWM control circuitry 116 may include one or more latches or flip-flops to generate and/or output the control signals.

To determine the duty cycles and periods of the switching signals, the PWM control circuitry 116 may receive SET and RESET signals. The SET signal may be generated by a pulse signal generator 123, which may be controlled by the clock signal CLK. In particular, the pulse signal generator 123 may be configured to generate a pulse signal on a rising edge of the clock signal CLK. The RESET signal may be output by a PWM comparator 118, which is described in more detail below. A period T of the clock signal may determine a period of the switching signals. A time difference Δt may determine the duty cycle of the switching signals. In particular, a duty cycle D may be determined by the following mathematical equation:

$$D = \frac{Δ t}{T} . \qquad ( 1 )$$

The current mode switching regulator 100 may include a feedback system for PWM control to regulate the DC output voltage V_{OUT} and to stabilize operation of the regulator 100. The feedback system may include a voltage feedback system and a current feedback system. By having a current feedback system or a combination of voltage and current feedback systems, the switching regulator 100 may be considered a current mode switching regulator.

The voltage feedback system may include an output voltage feedback loop feedback loop 119 that connects the output 103 of the regulator 100 with a first input of an error amplifier 120, and feeds back the DC output voltage V_{OUT} to the first input. The error amplifier 120 may be an operational amplifier (op-amp), as an example. As shown in FIG. 1, the first input of the error amplifier 120 may be a negative input terminal of the amplifier 120. In some example configurations, a feedback voltage divider 122, which may include a resistive network, may be included to voltage divide the DC output voltage V_{OUT} before the voltage is applied to the first input of the error amplifier 120. The error amplifier 120 may be configured to compare the DC output voltage V_{OUT} (or a voltage divided version of V_{OUT}) with a reference voltage V_{ref}, which may be applied to a second input, such as a positive input terminal, of the error amplifier 120. The reference voltage V_{ref} may be indicative of and/or proportional to a desired or predetermined DC output voltage. The error amplifier 120 may be configured to output a control signal, referred to as a PWM control signal, that is indicative of the comparison. In some example configurations, if the voltage applied to the first input is less than the reference voltage V_{ref}, then the error amplifier 120 may be configured to increase an output level of the PWM control signal, and if the voltage applied to the first input is greater than the reference voltage V_{ref}, then the error amplifier 120 may be configured to decrease the output level of the PWM control signal. Other configurations are possible.

The current feedback system may include current sensing circuitry 124, which may sense or monitor the current flowing through or into the switch transistors circuitry 104. For some configurations, the current sensing circuitry 124 may sense a voltage drop across a switch transistor in the switching circuitry, which may be indicative of the current flow through the inductor 104.

Output signals generated by the voltage and current feedback systems may be sent to inputs (e.g., positive and negative input terminals) of the PWM comparator 118. The PWM comparator 118 may be configured to compare the output of the voltage feedback system with the output from the current feedback voltage system. If the output from the current feedback system is equal to or exceeds the output from the voltage feedback system, the PWM comparator 118 may be configured to output the RESET signal to the PWM control circuitry 116, which may set or determine a corresponding duty cycle for the switching signals. Alternatively, if the output of the current feedback system is less than the output from the voltage feedback system, the PWM comparator 118 may be configured to not output a reset signal.

As previously described, the RESET signal received by the PWM control circuitry 116 may set or yield a duty cycle or pulse width of the switching signal. That is the duty cycle and/or the pulse width may correspond to the time difference Δt between the SET pulse and the RESET pulse. Through use of the voltage and current feedback systems, the pulse width or duty cycle of the PWM signals may be managed and/or adjusted so that a regulated DC output voltage V_{OUT} may be achieved.

Current mode switching regulators, such as the regulator 100 shown in FIG. 1, may become unstable without slope compensation when the duty cycle of the PWM signals exceeds 50%. One example of instability is sub-harmonic oscillation, where the voltage feedback system and the current feedback system generate opposing feedback responses in each period, creating a lower frequency (sub-harmonic) oscillation. The instability may be manifested in current I_{L} flowing through the inductor and switching circuitry 104 to the output 103. In general, due to switching of the switching circuitry 107, an amount of current flowing through the inductor and switching circuitry 104 may oscillate between minimum I_{L}(min) and maximum I_{L}(max) current levels. For example, the current I_{L} may ramp up from the minimum current level I_{L}(min) to the maximum current level I_{L}(max) during a ramp-up portion of the current flow, and may ramp down from the maximum current level I_{L}(max) to the minimum current level I_{L}(min) during a ramp-down portion of the current flow. Each of the ramp-up and ramp-down portions may have associates slopes. When the switching regulator is unstable, a deviation of the minimum current I_{L}(min) from a nominal value may increase on a cycle-by-cycle basis. When the duty cycle exceeds 50%, the magnitude of the slope of the ramp down portion of the current I_{L} may be greater than the magnitude of the slope of the ramp up portion of the current I_{L}, yielding the cycle-by-cycle increase in deviation.

The current mode switching regulator 100 may include slope compensation circuitry 102, which may generate an output signal that modifies the current sensing signal to reduce the instability. To modify the current sensing signal, the output signal of the slope compensation circuitry 102, referred to as a compensation ramp signal, may be sent to an adder or summation circuitry 126, which may also receive the current sensing signal from the current sensing circuitry 124. The summation circuitry 126 may add the current sensing signal with the compensation ramp signal to generate a modified current sensing signal, referred to as a PWM ramp signal. The PWM ramp signal may be sent to an input terminal of the PWM comparator 118, where it is compared with the PWM control signal received from the error amplifier 118. By comparing the PWM control signal (or the modified current sensing signal) with the PWM ramp signal from the adder 126, rather than with the current sensing signal directly from the current sensing circuitry 124, unstable operation of the current mode switching regulator 100 may be reduced.

FIG. 6 shows graphs of the clock signal CLK, the set signal SET, the PWM control signal, the PWM ramp signal, and the RESET signal. The clock signal CLK may oscillate between high and low values over a time period T. The SET signal may be pulsed at the rising edge of the clock signal CLK. When the set signal SET is pulsed, the PWM ramp signal may increase or ramp up to a level of the PWM control signal. When the level of the PWM ramp signal reaches the level of the PWM control signal, the PWM comparator 118 may output the reset signal RESET. A time difference Δt between the SET signal and the RESET signal may determine a duty cycle D.

For some configurations, multiple switching signals may be output to multiple switches in the switching circuitry. Some of the switches may turn “on” to control or determine the ramp up portion of the inductor current I_{L}, while other switches may turn “off.” Similarly, some of the switches may turn “on” to control or determine the ramp down portion of the inductor current I_{L}, while other switches may turn “off.” For these configurations, the duty cycle D may refer to the duty cycles of the switching signals that correspond to the ramp up portion of the inductor current I_{L}, or duty cycles of switching signal that turn the switches “on” for the ramp up portion of the inductor current I_{L}.

As previously described, instability may occur for duty cycles that exceed 50%. That is, when the duty cycles of the PWM signals are less than or equal to 50%, modification of the current sensing signal using slope compensation may be unnecessary. Moreover, performing slope compensation on current sensing signals having duty cycles less than or equal to 50% may result in over compensation, which may still cause instability. As such, it may be desirable to avoid or minimize slope compensation for duty cycles less than or equal to 50%. Some slope compensation techniques, such as linear slope compensation or non-linear second-order slope compensation, may not adequately minimize slope compensation for duty cycles less than or equal to 50%, which may result in over compensation and instability.

For stable operation, the slope compensation circuitry 102 ideally performs slope compensation and outputs the compensation ramp signal in accordance with the following mathematical function, referred to as the Deisch function:

$${V}_{ramp} ( t ) = \{ \begin{matrix}\frac{{V}_{out} {TR}_{S}}{2 L} ( 2 \frac{t}{T} - ln \frac{t}{T} - ln 2 e ) , & for t > \frac{T}{2} \\ 0 & for t \leq \frac{T}{2}\end{matrix} \qquad ( 2 )$$

where Vᵣₐₘₚ(t) is the compensation ramp signal as a function of time t, V_{OUT} is the DC output voltage, T is the period, Rₛ is a reference resistance related to the current sensing circuitry 124, L is an inductance value of the inductor 105, and T/2 is representative of a 50% duty cycle. To the slope compensation circuitry 102 to output a compensation ramp signal that resembles and/or approaches the Deisch function as close as possible.

The slope compensation circuitry 102 of the regulator 100 may generate a compensation ramp signal that is duty-cycle dependent of the duty cycles of the switching signals driving the switching circuitry 107 and that closely resembles the Deisch function. In particular, an output voltage of the compensation ramp signal may be duty-cycle dependent in that a voltage level or amplitude V_{RMP} to which the output voltage ramps up over the time period Δt may depend on the duty cycle, a slope of the curve of the amplitude V_{RMP} as a function of duty cycle may depend on the duty cycle, and the waveform of the output voltage of the PWM ramp signal may depend on the duty cycle.

To generate an output voltage that is dependent on a switching signal having a duty cycle that corresponds to the ramp up portion of the inductor current I_{L} (e.g., a switching signal that turns switches “on” to control the ramp up portion of the inductor current I_{L}), a signal proportional to the switching signal, such as a signal with the same duty cycle as the switching signal, may be applied to the slope compensation circuitry 102 as an input. The signal used may depend on the topology of the switching regulator used for the current mode switching regulator 100, such as those topologies corresponding to the ones shown in FIGS. 2-5. In some configurations, the signal used may be generated by the inductor and switching circuitry 104, as shown by feedback loop 128. In alternative configuration, the signal used may be generated directly from the PWM control circuitry 116, the driver circuitry 110, and/or using the SET and RESET signals. Various configurations are possible.

FIG. 7 shows a block diagram of the current mode switching regulator 100 shown in FIG. 1 having a step-down (buck) regulator topology. The example current mode switching buck regulator 700 may be configured to generate a DC output voltage V_{OUT} that is less than the input voltage V_{IN}. In one example, the DC input voltage may be 3.3 volts (V) and the DC output voltage may be 1.1 V, although other types of step-down conversions with other voltage levels may be performed.

An inductor L may deliver current I_{L} to the output 103 to generate and maintain the output voltage V_{OUT}. An average current I_{L} delivered through the inductor L to the output 103 may be equal or substantially equal to an output current at the output 103. The inductor L may have an end connected to the output 103 of the regulator 700 and an opposing end connected to a node SW in the switching circuitry 107.

The switching circuitry 107 for the example current mode buck regulator 700 may include a first switch 704 and a second switch 706. The first and second switches 704, 706 may be transistors of various types, such as bipolar junction transistors (BJTs) or field-effect transistors (FETs) (e.g., metal-oxide-semiconductor field-effect transistors (MOSFETs)), as examples. In the example current mode buck regulator 700, the first switch 704 is a p-channel metal-oxide-semiconductor (PMOS) transistor, and the second switch 706 is a n-channel MOS (NMOS) transistor, although other types of switches may be used. The PMOS transistor 704 may have a source terminal connected to an input node 108 that supplies the DC input voltage V_{IN} to the regulator 700, and a drain terminal connected to the node SW. The NMOS transistor 706 may have a drain terminal connected to the node SW and the drain terminal of the PMOS transistor 704, and a source terminal connected to ground GND, which may have a voltage potential of zero or substantially zero volts.

The PMOS and NMOS transistors 704, 706 may each switch between “on” and “off” states. In the “on” state, the transistors 704, 706 may exhibit relatively low resistance and a proportionately large amount of current may flow between the drain and source terminals. Alternatively, when the transistors 704, 706 are in the “off” state, they may exhibit a relatively infinite amount of resistance, and no current may flow between the drain and source terminals.

The PMOS and NMOS transistors 704, 706 may switch “on” and “off” cooperatively to generate a voltage signal V_{SW} at the node SW. By cooperatively switching, the voltage V_{SW} may oscillate or switch between a voltage level corresponding to a logic “high” value (referred to as logic “high”) and a voltage level corresponding to a logic “low” value (referred to as logic “low”). Voltage levels corresponding to logic “high” and logic “low” are used to refer to a logical association or relationship between the high and low levels, which are not meant to be limited to any particular set of voltage levels or values, or generated from logic operations. When the PMOS transistor 704 is “on” and the NMOS transistor 606 is “off,” the voltage V_{SW} generated at node SW may have a logic “high” voltage level. Alternatively, when the PMOS transistor 104 is “off” and the NMOS transistor 106 is “on,” the voltage V_{SW} generated at node SW may have a logic “low” voltage level. The logic “high” voltage level at node SW may be determined by the amount of voltage of the DC input voltage V_{IN}, less any voltage drop across the PMOS transistor 104, and the logic “low” voltage level may be at or near ground GND, higher by any voltage drop across the NMOS transistor 106.

The driver circuitry 110 of the example current mode buck regulator 700 may output switching signals to the PMOS and NMOS transistors 704, 706 to generate the logic “high” and logic “low” voltage levels of the voltage signal V_{SW}. In particular, the driver circuitry 110 may include PMOS driver circuitry 712 that may output a switching signal that is applied to a gate terminal of the PMOS transistor 704 to turn “on” and “off” the PMOS transistor 704. In addition, the driver circuitry 110 may include a NMOS driver circuitry 714 that may output a switching signal that is applied to a gate terminal of the NMOS transistor to turn “on” and “off” the NMOS transistor 706. In some example configurations, the switching signals may be pulse width modulated (PWM) signals having associated duty cycles, although other types of switching signals may be used.

The PMOS driver circuitry 712 and the NMOS driver circuitry 714 may output the switching signals to cooperatively turn “on” and “off” the PMOS and NMOS transistors 712, 174 to generate the logic “high” and logic “low” voltage levels for the voltage V_{SW}. In particular, the PMOS and NMOS driver circuitries 712, 714 may output switching signals so that the NMOS transistor 706 is “off” when the PMOS transistor 704 is “on” to generate a logic “high” voltage level for the voltage V_{SW}, and so that the PMOS transistor 704 is “off” when the NMOS transistor 706 is “on” to generate a logic “low” voltage level for the voltage V_{SW}.

The switching signals output by the PMOS and NMOS driver circuitries 712, 714 may have a period T that corresponds to the period of the clock signal CLK. In addition, the switching signals may have duty cycles that correspond to the time difference Δt between the SET and RESET signals, as previously explained. The duty cycle of the switching signal output by the PMOS driver circuitry 712 may be different than the duty cycle of the switching signal output by the NMOS driver circuitry 714, or they may correspond to different portions of the period T, because the PMOS and NMOS transistors 712, 714 may alternate being “on” and “off” to generate the different voltage levels of the voltage V_{SW}. As an illustration, if the duty cycle of the switching signal output by the PMOS driver circuitry is 40%, then the PMOS transistor 704 may be “on” for 40% of the clock period and “off” for 60% of the clock period. In turn, the duty cycle of the switching signal output by the NMOS driver circuitry 714 may be 60% so that the NMOS transistor 706 is “on” for the 60% of the clock period that the PMOS transistor 704 is “off,” and “on” for the 40% of the clock period that the PMOS transistor is “on.” Various configurations are possible.

A duty cycle of the voltage signal V_{SW} at node SW may correspond to the duty cycle of the switching signal applied to the PMOS transistor 704. When the PMOS transistor 704 is “on,” the voltage V_{SW} has a voltage level that is logic “high,” and when the PMOS transistor 704 is “off,” the voltage V_{SW} has a voltage level that is logic “low.” Using equation (1) above, where the switching cycle has a duty cycle D, the PMOS transistor 704 may be “on” for a time duration Δt over the period T, which in turn causes the voltage signal V_{SW} to have a logic “high” voltage level over the time duration Δt.

In addition, the voltage levels of the voltage V_{SW} may determine the ramp up and ramp down portions of the current flow. When the voltage V_{SW} has a logic “high” voltage level, the current I_{L} through the inductor L may linearly increase or “ramp up.” Alternatively, when the voltage V_{SW} is logic “low,” the current I_{L} may linearly decrease or “ramp down.” Based on the logic “high” and logic “low” voltage levels, the current I_{L} may ramp up and ramp down between maximum I_{L}(max) and minimum I_{L}(min) current values

The inductor current I_{L} may ramp up and then ramp down over consecutive periods T of the clock signal CLK. A portion of the period T over which the inductor current I_{L} ramps up may correspond to and/or be proportional to the duty cycle of the switching signal being applied to the PMOS transistor 704. That is, the duty cycle of the switching signal applied to the PMOS transistor 704 determines how long the PMOS transistor is “on,” which determines how long the voltage V_{SW} is logic “high,” which in turn determines the ramp up portion, including slope and duration, of the inductor current I_{L} over the period T.

The example current mode buck regulator 700 shown in FIG. 7 may generate a duty-cycle dependent slope compensation signal by receiving an input signal that has a duty cycle that corresponds and/or is proportional to the ramp up portion of the inductor current I_{L}. In the example buck regulator 700 shown in FIG. 7, the voltage signal V_{SW} may be used as the input to the slope compensation circuitry 102 because the voltage V_{SW} has a duty cycle that corresponds to the duty cycle of the switching signal that turns the PMOS transistor “on” to ramp up the inductor current I_{L}. In alternative configurations, signals other than the voltage signal V_{SW}, that have a duty cycle that corresponds to and/or is proportional to the ramp up portion of the inductor current I_{L} may be used.

FIG. 8 shows a schematic diagram of slope compensation circuitry 102. The slope compensation circuitry 102 may include a current source I₀ to generate an initial current to charge a capacitor C_{R} to generate a voltage V_{R}. In addition, the slope compensation circuit may include current mirror circuitry that uses current mirroring techniques to generate a first current I₁ to generate an output voltage V_{RMP} of the compensation ramp signal (i.e., the output of the slope compensation circuitry 102), which may be based on the voltage V_{R} across the capacitor C_{R}. The capacitor C_{R} may include a single capacitor, multiple capacitors, and/or other types of capacitive or storage devices or components configured to store or discharge a charge, and generate a voltage in proportion to the stored charge. The first current I₁ may be supplied to an output of the slope compensation circuitry to generate the output voltage V_{RMP}. The output may include an output load, such as output resistor R_{RMP}, to generate the output voltage V_{RMP} upon receipt of the first current I_{R}, although other types of output loads may be used. The voltage V_{R} across the capacitor C_{R} as a function of time may yield a voltage V_{RMP} that closely resembles the Deisch function over a range of duty cycles, from 0% to 100%.

The slope compensation circuitry 102 may include at least one first transistor Q₁ that generates and supplies the first current I₁ to the output resistor R_{RMP}. In one example, the first transistor Q₁ may be a PMOS transistor. A drain terminal of the first PMOS transistor Q₁ may be connected to the resistor R_{RMP}, and a source terminal of the first PMOS transistor Q₁ may be connected to a voltage source V_{cc}. In some examples, the voltage source V_{cc} may be the same as or common with the DC input voltage V_{IN}, although voltages other than V_{IN} may be used for the voltage source V_{cc}. The current flowing from the source to drain terminals of the first PMOS transistor Q₁ may be the same or substantially the same as the first current I₁ flowing through the first PMOS transistor Q.

To generate the first current I₁ based on the voltage V_{R}, the voltage V_{R} is converted to a second current I₂, which is then mirrored using current mirror circuitry to perform current mirroring. In particular, the slope compensation circuitry 102 may include a voltage-to-current converter 802 to convert the voltage V_{R} to the second current I₂. The voltage-to-current converter 802 may have a first input connected to the node 801 and that receives the voltage V_{R}. In some example configurations, the voltage-to-current converter 802 may include a second input, which may be connected to ground GND. The voltage-to-current converter 802 may have an associated transconductance gₘ, which may determine a ratio of a change in output current to a change in input voltage of the voltage-to-current converter 802. The output of the voltage-to-current converter 802 may be the second current I₂, which may be equal and/or proportional to product of voltage V_{R} and the associated transconductance gₘ.

The second current I₂ may have a negative polarity so that the second current I₂ flows toward the output of the voltage-to-current converter 802. Consequently, the first current I₁ may flow from the first PMOS transistor Q₁ to the output resistor R_{RMP}.

The slope compensation circuitry 102 may include at least one second transistor Q₂ that is connected to the output of the voltage-to-current converter 802 to supply the second current I₂. The second current I₂ may flow from the second transistor Q₂ to the output of the voltage-to-current converter 702. In one example embodiment, the second transistor Q₂ may be a PMOS transistor having a drain terminal connected to the output of the voltage-to-current converter 702. A source terminal of the second PMOS transistor Q₂ may be connected to the voltage source V_{cc}, and the current flowing from the source terminal to the drain terminal may be the same or substantially the same as the second current I₂

To mirror the first current I₁ to the second current I₂, the first and second transistors Q₁, Q₂ may be configured as current mirror circuitry in which both the gate terminal of the second PMOS transistor Q₂ and the gate terminal of the first PMOS transistor Q₁ may be connected to the drain terminal of the second transistor Q₂. As a result, the gate-to-drain voltage of the second PMOS transistor Q₂ may be zero volts, and the gate-to-source voltages of the first and second PMOS transistors Q₁, Q₂ may be the same, which may mirror the first current I₁ supplied by the first PMOS transistor Q₁ to the second current I₂ being supplied by the second PMOS transistor Q₂. By being mirrored, the first current I₁ may have the same or substantially the same magnitude as the second current I₂. In addition or alternatively, by being mirrored, the first current I₁ may be proportional to the second current I₂. The proportion may be based on one or more ratios of one or more properties of the first transistor Q₁ and the second transistor Q₂. One property may be size, such as the gate width, of the first transistor Q₁ and the second transistor Q₂. Another property may be a number of transistors. For example, the first transistor Q₁ and/or the second transistor Q₂ may include a single transistor or plurality of transistors connected in parallel. The amount of current of the first current I₁ may be proportional to the ratio of the size of the first transistor Q₁ to the size of the second transistor Q₂, a ratio of the number of the first transistors Q₁ to the number of the second transistors Q₂, or some combination thereof.

The voltage V_{R} across the capacitor C_{R} at node 801 may be generated from a pair of currents supplied to the capacitor C_{R}. The pair of currents may include a constant current I₀ supplied from a current source 704 and a third current I₃ that is mirrored to or a proportion of the second current I₂. As shown in FIG. 8, the third current I₃ may be combined with the constant current I₀ from the constant current source 804, such as at a circuit node A, and the combined current may be supplied to the capacitor C_{R} to generate the voltage V_{R}.

The third current I₃ may be mirrored to the second current I₂ using current mirroring techniques similar to those used to mirror the first current I₁ to the second current I₂. In particular, at least one third transistor Q₃ may be included as part of the current mirror circuitry in the slope compensation circuitry 802 to generate the third current I₃. The third transistor Q₃ may have a drain terminal connected to the capacitor C_{R} at node 801 and a source terminal connected to the voltage source V_{cc}. The third current I₃ may be the same or substantially the same as the current that flows through the source and drain terminals of the third PMOS transistor Q₃. In addition, a gate terminal of the third transistor Q₃ may be connected to the drain terminal of the second transistor Q₂ so that the gate-to-source voltage of the third PMOS transistor Q₃ is the same as the gate-to-source voltage of the second PMOS transistor Q₂, and the third current I₃ is mirrored the second current I₂. Similar to the amount of current generated for the first current I₁, the amount of the third current may be the same as and/or proportional to the second current I₂ based on the sizes and/or the numbers of the second and third transistors Q₂, Q₃. That is, the amount of third current I₃ may be proportional to the ratio of the size of the third transistor Q₃ to the size of the second transistor Q₂, a ratio of the number of the third transistors Q₃ to the number of the second transistors Q₂, or some combination thereof.

By charging the capacitor C_{R} with I₀ and a mirrored version of the second current I₂ (i.e., with the third current I₃), the voltage V_{R} generated across the capacitor C_{R} may be based or depend at least in part on the second current I₂. In this way, the slope compensation circuitry 102 includes a feedback system in which the voltage V_{R} generated across the capacitor C_{R} is fed back to the voltage-to-current converter 802, which generates the second current I₂, which in turn generates the third current I₃, which is supplied to the capacitor C_{R} to generate the voltage V_{R}. As such, the voltage V_{R} may be based or depend on the transconductance gₘ of the voltage-to-current converter 802 as well as the ratio between the numbers and/or sizes of the second and third transistors Q₂, Q₃ generating and supplying the second and third currents I₂, I₃.

The slope compensation circuitry 102 may include pull-down circuitry that is configured to pull down the voltage V_{R} to a low level corresponding to a “low” logic level based on the voltage signal V_{SW}. The logic “low” level pulled down by the pull-down circuitry may correspond and/or be proportional to the logic “low” level of the voltage V_{SW}. In one example configuration, the pull-down circuitry may include a pull-down transistor Q_{PD} connected in parallel with the capacitor C_{R}, although other pull-down configurations may be used. The pull-down transistor Q_{PD} may switch between an “on” state and an “off” state. In the “on” state, the pull-down transistor Q_{PD} may have a relatively low resistance and/or appear as a short circuit. As a result, in the “on” state, the pull-down transistor Q_{PD} may “pull down” the voltage V_{R} to a low voltage level, such as to ground or about zero volts, and/or to a logic “low” level. Alternatively, in the “off” state, the pull-down transistor Q_{PD} may have a relatively high or infinite resistance and/or appear as an open circuit. As a result, when the pull-down transistor Q_{PD} is “off,” the voltage V_{R} may depend on the currents I₀ and I₃ being supplied to the capacitor C_{R} at node 701.

The pull-down transistor Q_{PD} may receive an inverse voltage of the voltage signal V_{SW}, denoted as V̅_̅{̅S̅W̅}̅. When the inverse voltage signal V̅_̅{̅S̅W̅}̅ is logic “high,” the pull-down transistor Q_{PD} may be “on,” which in turn may pull down the voltage V_{R} to a low level. Alternatively, when the inverse voltage signal V̅_̅{̅S̅W̅}̅ is logic “low,” the pull-down transistor Q_{PD} may be “off,” which in turn may cause the voltage V_{R} to depend and/or be determined by the currents I₀ and I_{B}.

In this way, when the voltage signal V_{SW} is logic “high” and an increasing amount of the current I_{L} (i.e., the ramp up portion of the current I_{L}) is being supplied to the output 103, the voltage V_{R} generated across the capacitor C_{R} may depend on the currents I₀ and I₃. As previously described, the voltage signal V_{SW} may have a logic “high” value over a time duration Δt. Because the time duration Δt depends on the period T of the clock signal CLK and the duty cycle D of the switching signal driving the PMOS transistor 702 (FIG. 7) (i.e., the duty cycle corresponding to the ramp up portion of the inductor current), then the voltage V_{R} may depend on the duty cycle D and the period T of the clock signal CLK.

The voltage level to which the voltage V_{R} across the capacitor C_{R} increases over the time period Δt may be mathematically represented by the following formula:

$${V}_{R} = \frac{{I}_{0} \cdot T \cdot D}{C - {g}_{m} \cdot ( \frac{{m}_{3}}{{m}_{2}} ) \cdot T \cdot D} \qquad ( 3 )$$

where C represents a capacitance of the capacitor C_{R}, I₀ represents the current from the constant current source 804, m₃ represents the size and/or number of third transistors Q₃, m₂ represents the size and/or number of second transistors Q₂, T represents the period of the clock signal CLK, and D represents the duty cycle of switching signal driving the PMOS transistor 704. In addition, because the voltage V_{RMP} of the compensation ramp signal (i.e., the output of the compensation slope circuitry 102) depends on the voltage V_{R}, then the voltage V_{RMP} of the compensation ramp signal may also be duty-cycle dependent. The voltage V_{RMP} may be the voltage generated by the flow of the current I_{R} through the output resistor R_{RMP}, which may be represented by:

V_{RMP}=I_{R}*R_{RMP}. (4)

Because the first current I₁ is a mirrored version of the second current I₂, which is generated from the voltage V_{R}, then the voltage V_{RMP} may depend on the factors that the voltage V_{R} depends on, including the capacitance of the capacitor C_{R}, the current I₀ of the constant current source 704, the transconductance gₘ of the voltage-to-current converter 702, one or more ratios between the numbers and/or sizes of the second and third transistors Q₂, Q₃, the period of the clock signal CLK, and the duty cycle of the switching signal driving the PMOS transistor 704. The voltage V_{RMP} may further depend on the resistance of the output resistor R_{RMP} as well as one or more ratios between the numbers and/or sizes of the first and second transistors Q₁ and Q₂. The voltage level to which the voltage V_{RMP} ramps up to over the time duration Δt may be mathematically represented by the following formula:

$${V}_{RMP} = \frac{{R}_{RMP} \cdot {I}_{0} \cdot T \cdot D}{C - {g}_{m} \cdot ( \frac{{m}_{3}}{{m}_{2}} ) \cdot T \cdot D \cdot ( \frac{{m}_{1}}{{m}_{2}} )} , \qquad ( 5 )$$

where R_{RMP} represents a resistance of the output resistor R_{RMP} and m₁ represents the size and/or number of first transistors Q₁.

Additionally, the voltage level of V_{RMP} may be differentiated between levels when the voltage V_{SW} is at a logic “high” level and a logic “low” level, which may be mathematically represented by the following formula:

$${V}_{ramp} ( D ) = \{ \begin{matrix}\frac{{R}_{RMP} \cdot {I}_{0} \cdot T \cdot D}{C - {g}_{m} \cdot ( \frac{{m}_{3}}{{m}_{2}} ) \cdot T \cdot D \cdot ( \frac{{m}_{1}}{{m}_{2}} )} , & when {V}_{SW} is high \\ 0 , & when {V}_{SW} is low\end{matrix} \qquad ( 6 )$$

FIG. 9 shows graphs of the clock signal CLK, the set signal SET, the reset signal RESET, the voltage V_{SW}, the inverse voltage V̅_̅{̅S̅W̅}̅, and the compensation ramp signal. As shown in FIG. 9, the duty cycle D of the switching signal being applied to the PMOS transistor 704 is determined by the time duration Δt between the SET and RESET pulses, as previously described.

During the duration period Δt, the voltage V_{SW} may be high, and the inverse voltage V̅_̅{̅S̅W̅}̅ may be low, causing inductor current to increase or ramp up, and also causing the compensation ramp signal to increase or ramp up. Over the time duration Δt, the voltage of the compensation ramp signal may ramp up to the voltage level V_{RMP}, as described in equation (5). When the RESET signal is pulsed, the voltage V_{SW} may be low, and the inverse voltage V̅_̅{̅S̅W̅}̅ may be high, causing the inductor current to decrease or ramp down, and also causing the compensation ramp signal to drop to a voltage low. Because the time duration Δt depends on the duty cycle D, the output voltage of the compensation ramp signal also depends on the duty cycle. That is, the time portions Δt during which the output voltage is ramping up and (T−Δt) during which the output voltage is held to the voltage low depends on the duty cycle D; the amplitude V_{RMP} to which the output voltage increases over Δt depends on the duty cycle (as the duty cycle decreases, so does the amplitude V_{RMP}); and the slope of the curve of the amplitude of the output voltage V_{RMP} as a function of duty cycle depends on the duty cycle.

FIG. 10 shows a graph comparing the amplitude V_{RMP} of the output voltage of the slope compensation circuitry 102 with other slope compensation signals that may be generated using other types of slope compensation techniques as a function of duty cycle. A first curve 1002 shows a linear of fixed constant slope compensation curve. A second curve 1004 shows a prior non-linear or second-order slope compensation curve. A third curve 1006 shows the amplitude of the output voltage of the slope compensation circuitry 102 described in FIG. 8. A fourth curve 1008 shows a curve of the Deisch function. As shown in FIG. 10, the output of the slope compensation circuitry 102 as shown by the third curve 1006 is low or shows little compensation for duty cycles less than or equal to 50% due to its duty-cycle dependency. Additionally, as shown in FIG. 10, the output of the slope compensation circuitry 102 as shown by the third curve 1006 more closely resembles the Deisch function as compared to the linear compensation curve 1002 and the prior second-order curve 1004.

As graphically shown in FIG. 10, the slope of the curve of the amplitude V_{RMP} of the output voltage of the slope compensation circuitry 102 varies as a function of duty cycle D. The duty-cycle dependent slope S_{RMP}(D) may be mathematically represented by the following formula:

$${S}_{RMP} ( D ) = \frac{{R}_{RMP} \cdot {I}_{0} \cdot T \cdot C}{{( C - {g}_{m} \cdot ( \frac{{m}_{3}}{{m}_{2}} ) \cdot T \cdot D \cdot ( \frac{{m}_{1}}{{m}_{2}} ) )}^{2}} \qquad ( 6 )$$

FIG. 11 shows a flow chart of an example method 1100 of generating an output for slope compensation circuitry use to perform slope compensation for a current mode switching regulator. At block 1102, a pair of currents, including a first current and a second current, may be supplied to a storage device to charge the storage device. The first current may be supplied from a constant current source. The second current may be supplied from current mirror circuitry that mirrors a third current that is generated by a voltage-to-current converter, where an input to the voltage-to-current converter is a voltage generated across the storage device.

At block 1104, a switching signal with an associated period, such as a pulse wave or a rectangular wave signal, may be received by pull down circuitry that pulls down the voltage generated across the storage device to a low level, such as ground. The switching signal may oscillate or switch between voltage levels corresponding to logic “high” and the logic “low” levels in accordance with a duty cycle that corresponds to a ramp up portion of inductor current flowing through an inductor of the switching mode regulator. The switching signal may turn “off” the pull down circuitry over a first time duration of the period corresponding to the duty cycle so that the pair of currents charges the storage device over the first time duration. The switching signal may turn “on” the pull down circuitry over a second time duration of the period so that that the voltage level across the storage device is held to a voltage level corresponding to a logic low.

At block 1106, the voltage across the storage device may be generated based on the pair of currents supplied to the storage device and the voltage being pulled down by the pull down circuitry. Because the pull down circuitry switches “on” and “off” in accordance with a duty cycle corresponding to the ramp up portion, the voltage may depend on the duty cycle.

At block 1108, the voltage across the storage device may be supplied to a voltage-to-current converter, where the voltage is converted to the third current in accordance with an associated transconductance of the converter. At block 910, the third current may be mirrored with the current mirror circuitry to generate the second current. In addition, at block 910, the mirrored second current may be supplied to the storage device to generate the voltage across the capacitor.

At block 1112, the third current may be mirrored at a second instance with the current minor circuitry to generate a fourth current. The mirrored fourth current may be based on the constant current source, capacitance of the storage device, the transconductance of the voltage-to-current converter, ratios between transistors in the current mirror circuitry, and the duty cycle of the switching signal received by the pull down circuitry.

At block 1114, the mirrored fourth current may be supplied to an output load to generate an output voltage of the slope compensation circuitry. At block 1116, the output of the slope compensation circuitry may be sent to an adder or summation circuitry, where the output may be added with a current sensing signal indicative of the current being supplied to the inductor to perform the slope compensation.

It is intended that the foregoing detailed description be understood as an illustration of selected forms that the embodiments can take and does not intend to limit the claims that follow. Also, some of the following claims may state that a component is operative to perform a certain function or configured for a certain task. It should be noted that these are not restrictive limitations. It should also be noted that the acts recited in the claims can be performed in any order not necessarily in the order in which they are recited. Additionally, any aspect of any of the preferred embodiments described herein can be used alone or in combination with one another. In sum, although the present invention has been described in considerable detail with reference to certain embodiments thereof, other versions are possible. Therefore, the spirit and scope of the appended claims should not be limited to the description of the embodiments contained herein.

We claim:

1. A slope compensation circuit for performance of slope compensation of a current mode switching regulator, the switching regulator comprising switching circuitry to control flow of ramp up and ramp down portions of electrical current through an inductor to generate an output voltage, the switching circuitry responsive to a switching signal having a period comprising a first time duration corresponding to the ramp up portion and a second time duration corresponding to the ramp down portion, the first time duration proportional to a duty cycle of the switching signal, the slope compensation circuit comprising:
a storage device configured to generate a voltage;
pull down circuitry configured to pull down the voltage to a level corresponding to a logic low based on the duty cycle of the switching signal;
a voltage-to-current converter configured to generate a first current based on the voltage; and
current mirror circuitry configured to:
mirror the first current to generate a second current and supply the second current to the storage device for generation of the voltage; and
mirror the first current to generate a third current and supply the third current to an output of the slope compensation circuit for generation of a slope compensation output.

2. The slope compensation circuit of claim 1, wherein the current mirror circuitry comprises at least one first transistor that is configured to supply the first current to the voltage-to-current converter.

3. The slope compensation circuit of claim 2, wherein the current mirror circuitry further comprises at least one second transistor that is configured to mirror the first current to generate the second current and supply the second current to the storage device.

4. The slope compensation circuit of claim 3, wherein the current mirror circuitry further comprises at least one third transistor that is configured to mirror the first current to generate the third current and supply the third current to the output of the slope compensation circuit.

5. The slope compensation circuit of claim 4, wherein the first, second, and third transistors each comprise p-channel metal-oxide-semiconductor (PMOS) transistors.

6. The slope compensation circuit of claim 1, wherein the voltage is based on the second current over the first time duration of the period of the switching signal.

7. The slope compensation circuit of claim 6, wherein the pull down circuitry is configured to pull down the voltage to the low level in response over the second time duration of the period of the period of the switching signal.

8. The slope compensation circuit of claim 6, further comprising:
a constant current source configured to supply a fourth current to the storage device,
wherein the voltage is further based on the fourth current over the first time duration.

9. The slope compensation circuit of claim 1, wherein the voltage-to-current converter has an associated transconductance, and wherein the voltage generated across the storage device is based the associated transconductance.

10. The slope compensation circuit of claim 1, wherein the output of the slope compensation circuit has a voltage that increases to a voltage level over the first time duration, the voltage being represented by the mathematical formula:
$${V}_{RMP} = \frac{{R}_{RMP} \cdot {I}_{0} \cdot T \cdot D}{C - {g}_{m} \cdot ( \frac{{m}_{3}}{{m}_{2}} ) \cdot T \cdot D \cdot ( \frac{{m}_{1}}{{m}_{2}} )} ,$$
wherein R_{RMP} is a resistance of an output resistor in the output of the slope compensation circuit, (m₃/m₂) is a ratio of at least one of a size or number of transistors of at least one third transistor generating the third current to at least one second transistor generating the second current, gₘ is the transconductance of the voltage-to-current converter, I₀ is an amount of current supplied to the storage device by a constant current source, T is the period of the switching signal, D is the duty cycle of the switching signal, C is a capacitance of the storage device, and (m₁/m₂) is a ratio of at least one of a size or number of transistors of at least one first transistor generating the first current to the at least one second transistor generating the second current.

11. A method of generating a slope compensation signal for performance of slope compensation for a current mode switching regulator, the switching regulator comprising switching circuitry to control flow of ramp up and ramp down portions of electrical current through an inductor to generate an output voltage, the switching circuitry responsive to a switching signal having a period comprising a first time duration corresponding to the ramp up portion and a second time duration corresponding to the ramp down portion, the first time duration proportional to a duty cycle of the switching signal, the method comprising:
generating a voltage across a storage device, wherein generating the voltage comprises pulling down the voltage to a low level corresponding to a logic low based on the duty cycle of the switching signal;
supplying the voltage to a voltage-to-current converter;
generating, with the voltage-to-current converter, a first current based on the supplied voltage;
mirroring, with current mirror circuitry, the first current to generate a second current;
supplying, with the current mirror circuitry, the second current to the storage device to generate the voltage across the storage device;
mirroring, with the current mirror circuitry, the first current to generate a third current;
generating, with an output load, a slope compensation output based on the third current.

12. The method of claim 11, wherein the switching signal comprises a first switching signal, the method further comprising:
receiving, with pull down circuitry, a second switching signal to pull down the voltage to the low level.

13. The method of claim 12, wherein the second switching signal is inverted from the first switching signal.

14. The method of claim 11, wherein generating the voltage further comprises:
generating the voltage based on the second current over the first time duration of the period of the switching signal.

15. The method of claim 14, wherein pulling down the voltage comprises pulling down the voltage to the low level over the second time duration.

16. The method of claim 14, further comprising:
supplying, with a constant current source, a fourth current to the storage device,
wherein generating the voltage further comprises generating the voltage based on the fourth current over the first time duration.

17. A current mode switching regulator configured to output a regulated output voltage; the regulator comprising:
an inductor configured to supply an inductor current to an output of the regulator to generate the regulated output voltage, the inductor current comprising a ramp up portion and a ramp down portion;
switching circuitry configured to control the ramp up and ramp down portions of the inductor current, the switching circuitry responsive to a switching signal having a period comprising a first time duration corresponding to the ramp up portion and a second time duration corresponding to the ramp down portion, the first time duration proportional to a duty cycle of the switching signal; and
slope compensation circuitry comprising:
a storage device configured to generate a voltage;
pull down circuitry configured to pull down the voltage to a level corresponding to a logic low based on the duty cycle;
a voltage-to-current converter configured to generate a first current based on the voltage; and
current mirror circuitry configured to:
mirror the first current to generate a second current and supply the second current to the storage device for generation of the voltage; and
mirror the first current to generate a third current and supply the third current to an output of the slope compensation circuitry for generation of a slope compensation output.

18. The current mode switching regulator of claim 17, further comprising:
current sensing circuitry configured to output a current sensing signal indicative of current flowing to the inductor;
summation circuitry configured to add the output of the slope compensation circuitry with the current sensing signal to perform slope compensation.

19. The current mode switching regulator of claim 17, wherein the storage device is configured to generate the voltage based on the second current over the first time duration corresponding to the ramp up portion, and wherein the pull down circuitry is configured to pull down the voltage to the low level over the second time duration corresponding to the ramp down portion.

20. The current mode switching regulator of claim 17, wherein the current mode switching regulator comprises a current mode step-down regulator.
